(19) United States
(12) Patent Application Publication
(10) Pub. No.: US 2025/0227805 A1
(43) Pub. Date: Jul. 10, 2025

(54) COMMUNICATION METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/093,589

(22) Filed: Mar. 28, 2025

Related U.S. Application Data
(63) Continuation of application No. PCT/JP2023/035054, filed on Sep. 27, 2023.
(60) Provisional application No. 63/410,725, filed on Sep. 28, 2022.

(51) Int. Cl. H04W 76/27; H04W 76/34; H04W 76/40

(52) U.S. Cl. CPC H04W 76/27; H04W 76/34; H04W 76/40

(57) ABSTRACT

A communication method used in a mobile communication system that provides a multicast/broadcast service (MBS) includes the steps of: receiving, by a user equipment being in a radio resource control (RRC) inactive state and having joined a multicast session, multicast data from a network node via the multicast session; and determining, by the user equipment, to transition from the RRC inactive state to an RRC connected state in response to detection of generation of uplink data belonging to the multicast session.

### RELATED APPLICATIONS

The present application is a continuation based on PCT Application No. PCT/JP2023/035054, filed on Sep. 27, 2023, which claims the benefit of U.S. Provisional Patent Application No. 63/410,725 filed on Sep. 28, 2022. The content of which is incorporated by reference herein in their entirety.

### TECHNICAL FIELD

The present disclosure relates to a communication method used in a mobile communication system.

### BACKGROUND

The 3rd Generation Partnership Project (3GPP) has defined the technical specifications of New Radio (NR) that is radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR (for example, see Non-Patent Document 1).

### CITATION LIST

### Non-Patent Literature

Non-Patent Document 1: 3GPP Technical Specification: TS 38.300 V17.1.0

### SUMMARY

In a first aspect, a communication method is used in a mobile communication system that provides a multicast/broadcast service (MBS), the communication method including the steps of: receiving, by a user equipment being in a radio resource control (RRC) inactive state and having joined a multicast session, multicast data from a network node (or a network apparatus) via the multicast session; and determining, by the user equipment, to transition from the RRC inactive state to an RRC connected state in response to detection of generation of uplink data belonging to the multicast session.

In a second aspect, a communication method is used in a mobile communication system that provides a multicast/broadcast service (MBS), the communication method including the steps of: receiving, by a user equipment in a radio resource control (RRC) connected state, a multicast configuration required for reception of a multicast session together with version information of the multicast configuration from a network node; storing, by the user equipment, the version information; and receiving, by the user equipment having transitioned from the RRC connected state to an RRC inactive state, broadcast information from the network node, the broadcast information including version information of a latest multicast configuration of the multicast session.

In a third aspect, a communication method is used in a mobile communication system that provides a multicast/broadcast service (MBS), the communication method including the steps of: receiving, by a user equipment being in a radio resource control (RRC) inactive state and having joined a multicast session, multicast data from a network node via the multicast session; and receiving, by the user equipment, identification information of one or more multicast sessions to be released or deactivated from the network node.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIGS. 6A and 6B are diagrams for explaining an operation that enables UE in an RRC inactive state to perform multicast reception.

FIG. 7 is a flowchart illustrating an operation example of the mobile communication system according to a first operation pattern.

FIG. 8 is a flowchart illustrating an operation example of the mobile communication system according to a second operation pattern.

FIG. 9 is a flowchart illustrating an operation example of the mobile communication system according to a third operation pattern.

### DESCRIPTION OF EMBODIMENTS

A mobile communication system according to an embodiment is described with reference to the drawings. In the description of the drawings, the same or similar parts are denoted by the same or similar reference signs.

### (1) System Configuration

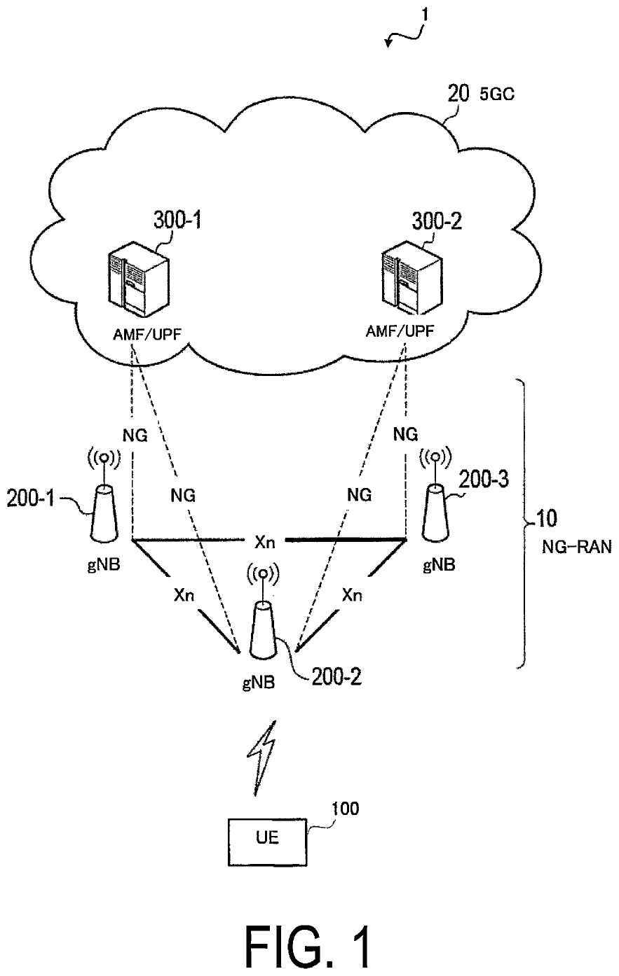

FIG. 1 is a diagram illustrating a configuration of a mobile communication system 1 according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10 (a network 10). The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (vehicle UE), and a flying object or an apparatus provided on a flying object (aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

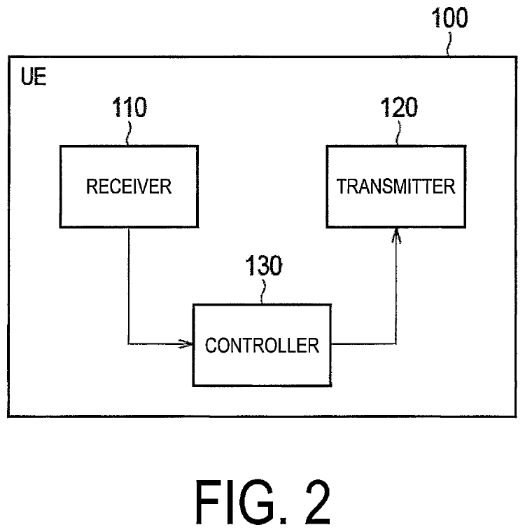

FIG. 2 is a diagram illustrating a configuration of the UE 100 (user equipment) according to an embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The operations of the UE 100 described above and below may also be performed under the control of a controller 230. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

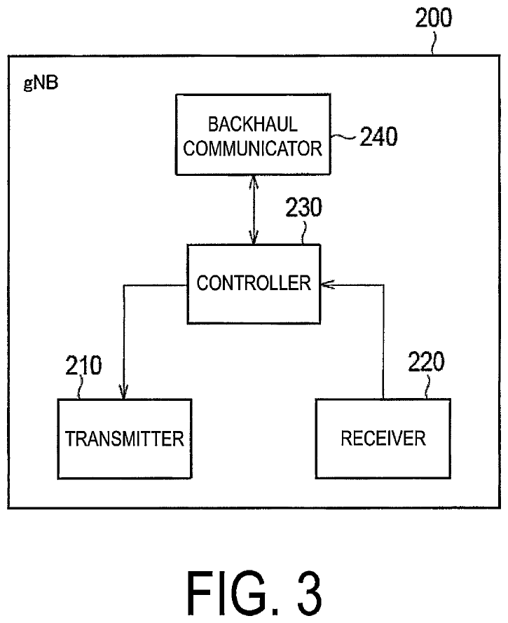

FIG. 3 is a diagram illustrating a configuration of the gNB 200 (base station) according to an embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The operations of the gNB 200 described above and below may also be performed under the control of the controller 230. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both units may be connected via an F1 interface that is a fronthaul interface.

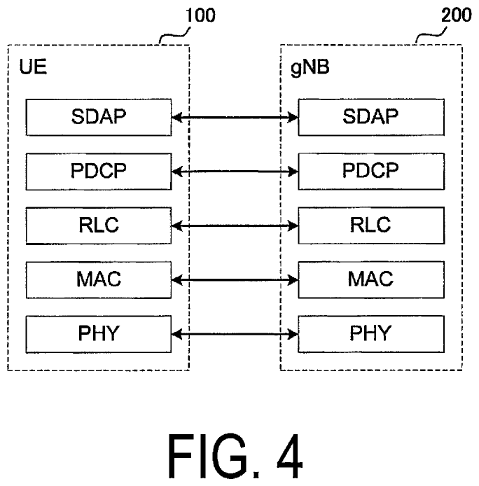

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

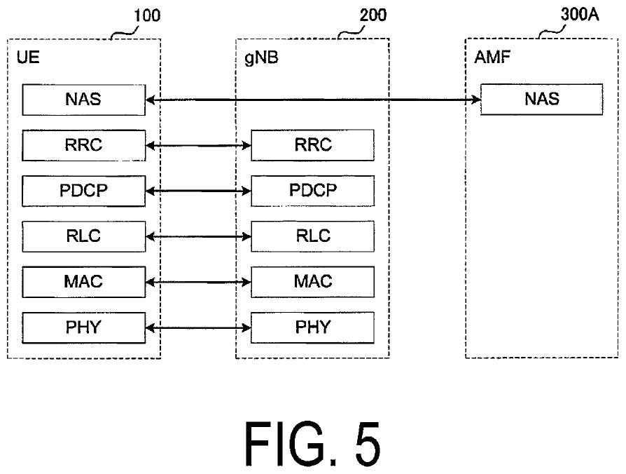

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection is present between the RRC of the UE 100 and the RRC of the gNB 200 (RRC connection), the UE 100 is in an RRC connected state. When no connection is present between the RRC of the UE 100 and the RRC of the gNB 200 (RRC connection), the UE 100 is in an RRC idle state. When the connection between the RRC of the UE 100 and the RRC of the gNB 200 is suspended, the UE 100 is in an RRC inactive state.

The NAS layer that is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### (2) Overview of MBS

The mobile communication system 1 can perform delivery with high resource efficiency by using the multicast/broadcast service (MBS).

In a multicast communication service (also referred to as “MBS multicast”), the same service and the same specific content data are simultaneously provided to a specific UE set. That is, not every UE 100 in the multicast service area is allowed to receive data. The multicast communication services are delivered to the UE 100 using a multicast session, which is a type of MBS session. The UE 100 can receive the multicast communication services in the RRC connected state using mechanisms such as Point-to-Point (PTP) and/or Point-to-Multipoint (PTM) delivery. The UE 100 may receive the multicast communication services in the RRC inactive (or RRC idle) state. Such a delivery mode is also referred to as “delivery mode 1”.

In the broadcast communication services (also referred to as “MBS broadcast”), the same service and the same specific content data are provided simultaneously to every UE 100 within a geographic area. That is, every UE 100 in the broadcast service area is allowed to receive the data. The broadcast communication services are delivered to the UE 100 using a broadcast session, which is a type of MBS session. The UE 100 can receive the broadcast communication services in any state of the RRC idle state, the RRC inactive state, and the RRC connected state. Such a delivery mode is also referred to as “delivery mode 2”.

Main logical channels used for MBS delivery are a multicast traffic channel (MTCH), a dedicated traffic channel (DTCH), and a multicast control channel (MCCH). The MTCH is a PTM downlink channel for transmitting MBS data of either a multicast session or a broadcast session from the network 10 to the UE 100. The DTCH is a PTP channel for transmitting MBS data of a multicast session from the network 10 to the UE 100. The MCCH is a PTM downlink channel for transmitting MBS broadcast control information associated with one or more MTCHs from the network 10 to the UE 100.

Regarding a configuration in MBS broadcast, the UE 100 in the RRC idle state, the RRC inactive state, or the RRC connected state receives an MBS configuration for a broadcast session (e.g., parameters required for MTCH reception) via the MCCH. Parameters required for reception of the MCCH (MCCH configuration) are provided through system information. In particular, system information block type 20 (SIB 20) includes the MCCH configuration. Note that SIB type 21 (SIB 21) includes information related to service continuity of MBS broadcast reception. The MCCH provides a list of all broadcast services including ongoing sessions transmitted on the MTCH, and the related information of the broadcast session includes an MBS session ID (e.g., Temporary Mobile Group Identity (TMGI)), related MTCH scheduling information, and information about neighboring cells providing a specific service on the MTCH.

On the other hand, with respect to MBS multicast, the current technical specifications of the 3GPP enable the UE 100 to receive data of multicast sessions only in RRC connected state. When the UE 100 joining a multicast session is in the RRC connected state and the multicast session is activated, the gNB 200 transmits an RRC reconfiguration message including an MBS configuration related to the multicast session to the UE 100. Such an MBS configuration is also referred to as a multicast radio bearer (MRB) configuration, an MTCH configuration, or a multicast configuration. Such an MRB configuration (MRB-ToAddMod) includes an MBS session ID (mbs-SessionId), an MRB ID (mrb-Identity), and other parameters of a PDCP configuration (pdcp-Config) for an MRB (multicast MRB) to be configured for the UE 100.

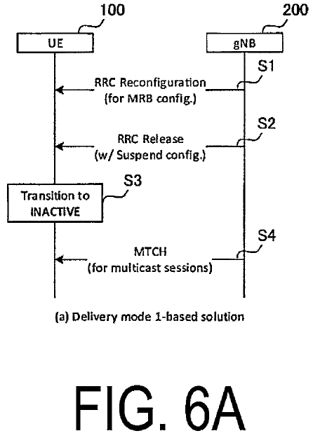

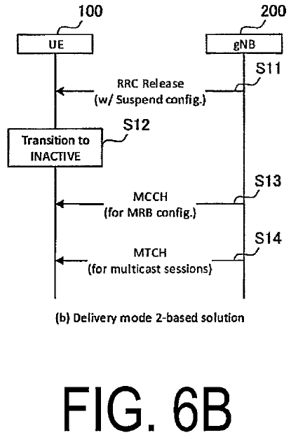

In the following embodiment, an operation of enabling the UE 100 in the RRC inactive state to perform multicast reception will be mainly described. FIGS. 6A and 6B illustrate an overview of the operation.

As a solution for the UE 100 in the RRC inactive state to perform multicast reception, a solution based on the delivery mode 1 illustrated in FIG. 6A and a solution based on the delivery mode 2 illustrated in FIG. 6B are considered.

In the solution based on the delivery mode 1 illustrated in FIG. 6A, in step S1, the gNB 200 transmits an RRC Reconfiguration message including the MBS configuration (multicast configuration) related to multicast sessions to the UE 100 in the RRC connected state. The UE 100 receives the multicast data on the MTCH via the multicast sessions (multicast MRB) based on the multicast configuration received in the RRC Reconfiguration message.

In step S2, the gNB 200 transmits an RRC release (Release) message for causing the UE 100 to transition to the RRC inactive state to the UE 100 in the RRC connected state. The RRC Release message includes a configuration (Suspend Config.) for the RRC inactive state.

In step S3, the UE 100 transitions from the RRC connected state to the RRC inactive (INACTIVE) state in response to receiving the RRC Release message in step S2.

In step S4, the UE 100 in the RRC inactive state continues using the multicast configuration of step S1 to receive the multicast data on the MTCH through the multicast sessions.

This enables the UE 100 in the RRC inactive state to perform multicast reception. Note that, although an example in which multicast configuration is performed using an RRC Reconfiguration message has been described, multicast configuration may be performed using an RRC Release message.

Both the RRC Reconfiguration message and the RRC Release message are RRC messages transmitted per UE on the dedicated control channel (DCCH), and are hereinafter also referred to as dedicated RRC messages.

On the other hand, in the solution based on the delivery mode 2 illustrated in FIG. 6B, in step S11, the gNB 200 transmits an RRC Release message for causing the UE 100 to transition to the RRC inactive state to the UE 100 in the RRC connected state. The RRC Release message includes a configuration (Suspend Config.) for the RRC inactive state.

In step S12, the UE 100 transitions to the RRC inactive (INACTIVE) state in response to receiving the RRC Release message in step S11.

In step S13, the gNB 200 transmits the MCCH including the MBS configuration (multicast configuration) for the multicast sessions. The UE 100 receives the MCCH. Note that the UE 100 receives the SIB 20 prior to the reception of the MCCH, and receives the MCCH based on the SIB 20. MCCH transmission (and reception) may be performed before step S11 or may be performed simultaneously with step S11.

In step S14, the UE 100 in the RRC inactive state receives the multicast data on the MTCH via the multicast sessions based on the multicast configuration received on the MCCH in step S13. This enables the UE 100 in the RRC inactive state to perform multicast reception.

### (3) System Operation Example

An operation of the mobile communication system 1 according to an embodiment will be described. The operation with respect to the embodiment is about the UE 100 in the RRC inactive state performing multicast reception.

### (3.1) First Operation Pattern: Operation for Uplink Transmission

The UE 100 is not able to perform uplink (UL) transmission in the RRC inactive state. When the application corresponding to a multicast session is an application such as television broadcasting, no particular problem arises, but when the application is for group calls, or the like, the UE 100 may need to perform UL transmission.

In the present operation pattern, the UE 100 that is in the RRC inactive state and has joined a multicast session receives multicast data from gNB 200 via the multicast session. The UE 100 determines whether to transition from the RRC inactive state to the RRC connected state upon detection of the generation of UL data belonging to the multicast session. Thus, even when the application corresponding to the multicast session is an application such as a group call, the UE 100 can perform UL transmission by transitioning to the RRC connected state in response to the generation of UL data belonging to the multicast session.

After that, the UE 100 starts an RRC recovery process for transitioning to the RRC connected state. The UE 100 may transmit notification information indicating the generation of the UL data belonging to the multicast session to the gNB 200 in the RRC recovery process. Accordingly, the gNB 200 can smoothly perform RRC recovery. The gNB 200 may configure a PTP leg in the MRB corresponding to the multicast session or may configure the PTP leg in a split MRB capable of PTP transmission.

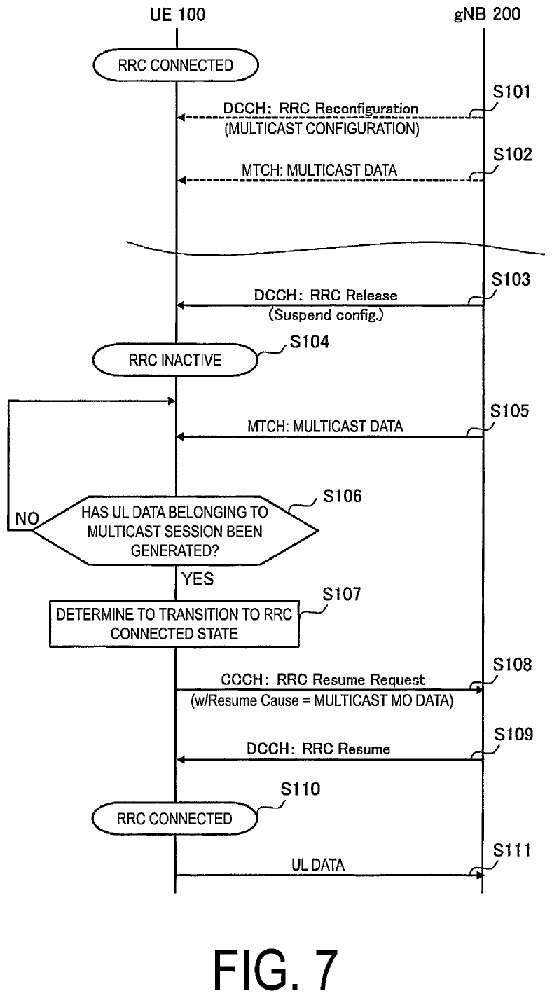

FIG. 7 is a flowchart illustrating an operation example of the mobile communication system 1 according to the present operation pattern. Prior to the present operation, it is assumed that the UE 100 has joined a multicast session.

In step S101, the gNB 200 may transmit a multicast configuration necessary for reception of a multicast session (that is, multicast reception) to the UE 100 in the RRC connected state in a dedicated RRC message. Although the dedicated RRC message is an RRC Reconfiguration message in the illustrated example, the dedicated RRC message may be an RRC Release message (step S103). The UE 100 may receive the multicast configuration in a dedicated RRC message. The UE 100 may receive the multicast configuration on the MCCH.

In step S102, the gNB 200 may transmit multicast data on the MTCH through the multicast session based on the multicast configuration. The UE 100 may receive the multicast data on the MTCH through the multicast session based on the multicast configuration.

In step S103, the gNB 200 transmits the RRC Release message including Suspend config. to the UE 100. The UE 100 receives the RRC Release message. The RRC Release message may include a multicast configuration required for reception of the multicast session.

In step S104, the UE 100 transitions to the RRC inactive state from the RRC connected state upon reception of the RRC Release message.

In step S105, the UE 100 in the RRC inactive state receives the multicast data on the MTCH via the multicast sessions based on the multicast configuration. The UE 100 receives the multicast data on the MTCH via the multicast session based on the multicast configuration.

In step S106, the UE 100 in the RRC inactive state checks whether UL data belonging to the multicast session has been generated.

When the generation of UL data belonging to the multicast session has been detected (step S106: YES), the UE 100 in the RRC inactive state determines in step S107 to transition to the RRC connected state and starts the RRC recovery process.

In step S108, the UE 100 in the RRC inactive state transmits an RRC Resume Request message to the gNB 200 to request recovery of an RRC connection. Here, the UE 100 may include notification information indicating the generation of UL data belonging to the multicast session in the RRC Resume Request message. The notification information may be set in a Resume Cause (recovery cause) field in the RRC Resume Request message. The notification information may be information such as multicast Mobile Originated (MO) data. The notification information may be information that the NAS of the UE 100 notifies the AS (for example, the RRC layer).

In step S109, the gNB 200 transmits an RRC Resume message to the UE 100 in response to the reception of the RRC Resume Request message.

In step S110, the UE 100 transitions from the RRC inactive state to the RRC connected state upon reception of the RRC Resume message. The gNB 200 may configure a PTP leg in the MRB corresponding to the multicast session. The gNB 200 may configure the MRB as a split MRB.

In step S111, the UE 100 having transitioned to the RRC connected state transmits UL data to the gNB 200. The gNB 200 receives the UL data.

In the illustrated example, the UE 100 may include notification information indicating the generation of UL data belonging to the multicast session in the RRC Resume Request message. However, after transitioning to the RRC connected state, the UE 100 may include the notification information in an RRC message, for example, a UE Assistance Information message, and transmit the notification information to the gNB 200.

### (3.2) Second Operation Pattern: Operation to Change Multicast Configuration

Here, a delivery mode 1-based solution is assumed. In the delivery mode 1-based solution, after the gNB 200 performs a multicast configuration for the UE 100 using a dedicated RRC message, the UE 100 performs multicast reception in the RRC inactive state based on the multicast configuration. Note that, the UE 100 in the RRC inactive state can receive the dedicated RRC message.

Here, it is assumed that the gNB 200 updates the multicast configuration (e.g., MTCH scheduling) for some reason. In order for the UE 100 to continue multicast reception, the updated multicast configuration needs to be configured for the UE 100 again.

In order to configure the updated multicast configuration in the UE 100, the UE 100 needs to perform the RRC recovery process and transition to the RRC connected state. However, since the UE 100 in the RRC inactive state cannot ascertain that the gNB 200 has changed the multicast configuration, voluntary start of the RRC recovery process is difficult for the UE 100.

In the present operation pattern, the gNB 200 transmits the multicast configuration necessary for the UE 100 in the RRC connected state to receive a multicast session together with version information of the multicast configuration to the UE 100. To be specific, the gNB 200 transmits a dedicated RRC message including a set of multicast configuration and version information to the UE 100. The version information is a variable counted up when the corresponding multicast configuration is updated. Hereinafter, such version information is also referred to as a “Value Tag”.

The UE 100 stores the multicast configuration and version information received from the gNB 200. After transitioning from the RRC connected state to the RRC inactive state, the UE 100 receives broadcast information including version information (Value Tag) of the latest multicast configuration of the multicast session from the gNB 200. As a result, the UE 100 can ascertain whether the multicast configuration stored in the UE 100 itself (i.e., the currently applied multicast configuration) is in the latest state or the old state.

The UE 100 determines to transition from the RRC inactive state to the RRC connected state based on the difference between the version information in the broadcast information and the stored version information. Accordingly, the UE 100 transitions to the RRC connected state and can receive the dedicated RRC message including the latest multicast configuration from the gNB 200.

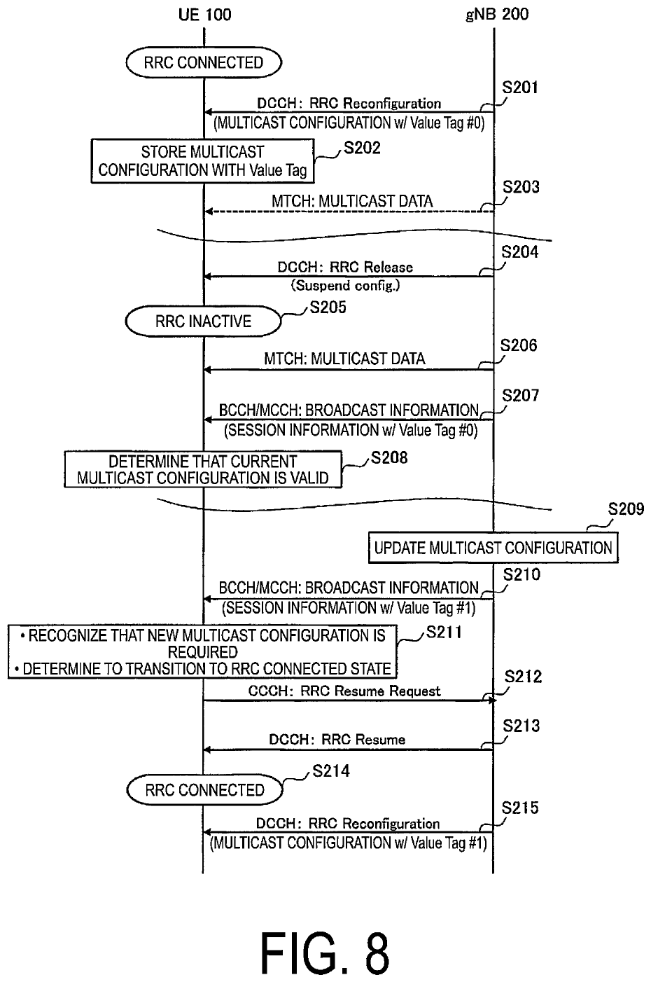

FIG. 8 is a flowchart illustrating an operation example of the mobile communication system 1 according to the present operation pattern. Prior to the present operation, it is assumed that the UE 100 has joined a multicast session. Here, differences from the first operation pattern described above will be mainly described, and overlapping description will be omitted.

In step S201, the gNB 200 may transmit a multicast configuration necessary for reception of a multicast session (that is, multicast reception) together with the Value Tag of the multicast configuration to the UE 100 in the RRC connected state in a dedicated RRC message. The multicast configuration may include the Value Tag. The multicast configuration may include a session identifier (TMGI) of the multicast session. The Value Tag may be associated with the session identifier (TMGI). In the illustrated example, it is assumed that the value of the Value Tag is “#0”.

Note that, although the dedicated RRC message is an RRC Reconfiguration message in the illustrated example, the dedicated RRC message may be an RRC Release message (step S203). The UE 100 receives the multicast configuration and Value Tag in the dedicated RRC message.

In step S202, the UE 100 in the RRC connected state stores the multicast configuration in association with the Value Tag received in step S201, and uses the multicast configuration for multicast reception.

In step S203, the gNB 200 may transmit multicast data on the MTCH through the multicast session based on the multicast configuration that the UE 100 was notified of. The UE 100 may receive the multicast data on the MTCH through the multicast session based on the stored multicast configuration.

In step S204, the gNB 200 transmits an RRC Release message including Suspend config. to the UE 100. The UE 100 receives the RRC Release message. The RRC Release message may include a multicast configuration and the Value Tag required for reception of the multicast session. The multicast configuration may include the session identifier (TMGI) of the multicast session. The Value Tag may be associated with the session identifier (TMGI).

In step S205, the UE 100 transitions to the RRC inactive state from the RRC connected state upon reception of the RRC Release message.

In step S206, the gNB 200 may transmit multicast data on the MTCH through the multicast session based on the multicast configuration that the UE 100 was notified of. The UE 100 in the RRC inactive state may receive the multicast data on the MTCH through the multicast session based on the stored multicast configuration.

In step S207, the gNB 200 transmits broadcast information including the value of currently valid Value Tag, that is, the value of the Value Tag of the latest multicast configuration. The UE 100 receives the broadcast information. The broadcast information may include a session identifier (TMGI) for each multicast session being provided by the gNB 200. In the broadcast information, the Value Tag may be associated with the session identifier (TMGI). Here, since the multicast configuration corresponding to the multicast session that the UE 100 is receiving has not been updated, the value of the Value Tag for the multicast session remains as “#0”.

The broadcast information may be a system information block (SIB) broadcast on a Broadcast Control CHannel (BCCH). The SIB may be SIB type 1, SIB type 20 (MCCH configuration), SIB type 21 (service continuity information), or a newly defined SIB. The broadcast information may be information broadcast on the MCCH. The broadcast information may be a paging message broadcast on the PCCH. Alternatively, the broadcast information may be a MAC CE that is multicast using a group RNTI (G-RNTI).

In step S208, the UE 100 in the RRC inactive state compares the Value Tag received in step S207 (to be more specific, the Value Tag corresponding to the multicast session that the UE 100 is receiving) with the stored Value Tag, and determines that the Value Tags match. In this case, the UE 100 in the RRC inactive state regards the currently stored (applied) multicast configuration as valid, and continues using the multicast configuration to perform multicast reception.

In step S209, the gNB 200 updates the multicast configuration for the multicast session that the UE 100 is receiving. In response to the update of the multicast configuration, the gNB 200 counts up (increments) the Value Tag corresponding to the multicast session to “#1”.

In step S210, the gNB 200 transmits broadcast information including the value of currently valid Value Tag, that is, the value of the Value Tag of the latest multicast configuration. Here, the value of the latest Value Tag corresponding to the multicast session that the UE 100 is receiving is “#1”. The UE 100 receives the broadcast information.

In step S211, the UE 100 in the RRC inactive state compares the Value Tag received in step S210 (to be more specific, the Value Tag corresponding to the multicast session that the UE 100 is receiving) with the stored Value Tag. Here, since the value of the Value Tag stored in the UE 100 is “#0” and the value of the latest Value Tag received from the gNB 200 is “#1”, the UE 100 determines that the two values do not match. In this case, the UE 100 in the RRC inactive state considers that the currently stored (applied) multicast configuration is old, determines to transition to the RRC connected state in order to acquire a new multicast configuration, and starts the RRC recovery process.

In step S212, the UE 100 in the RRC inactive state transmits an RRC Resume Request message to the gNB 200 to request recovery of an RRC connection. Here, the UE 100 may include notification information indicating a request for acquisition of a new multicast configuration in the RRC Resume Request message. The notification information may be set in a Resume Cause (recovery cause) field in the RRC Resume Request message.

In step S213, the gNB 200 transmits an RRC Resume message to the UE 100 in response to the reception of the RRC Resume Request message.

In step S214, the UE 100 transitions from the RRC inactive state to the RRC connected state upon reception of the RRC Resume message.

In step S215, the gNB 200 transmits a new multicast configuration together with its Value Tag to the UE 100 that has transitioned to the RRC connected state by using a dedicated RRC message. The UE 100 in the RRC connected state stores the multicast configuration in association with the Value Tag received in step S215, and uses the multicast configuration for multicast reception.

### (3.3) Third Operation Pattern: Operation for Session Release

In the present operation pattern, it is assumed that, when the UE 100 is receiving a multicast session in the RRC inactive state, the network side releases the multicast session. Because the operation at the time of general session releasing involves reception of PDU Session Modification of the NAS and transmission of Ack, the UE 100 needs to be in the RRC connected state.

For this reason, when a multicast session that a plurality of UEs 100 are receiving in the RRC inactive state is released, it is conceivable that the gNB 200 invokes each of the UEs 100 using paging messages and causes each of the UEs 100 to transition to the RRC connected state. In this case, the identifiers of the UEs 100 need to be contained in the paging messages, which creates a problem of increased sizes of the paging messages.

When the multicast session is released, canceling the multicast configuration configured to the UE 100 is preferable. When the multicast configuration is maintained, even if no multicast data is transmitted, the UE 100 continues attempting multicast reception while remaining in the RRC inactive state, which also creates a problem of increased power consumption in the UE 100.

Although the release of the multicast session has been mainly described in the present operation pattern, the present operation pattern is also applicable to a case in which the multicast session is temporarily deactivated.

In the present operation pattern, the UE 100 performing multicast reception in the RRC inactive state receives identification information of one or more multicast sessions to be released or deactivated from the gNB 200. The gNB 200 may transmit a paging message including the identification information or a media access control and control element (MAC CE) including the identification information. Accordingly, the UE 100 can specify (recognize) the release or deactivation of the multicast session that the UE 100 is receiving itself based on the identification information included in the paging message or the MAC CE. Thus, the UE 100 recognizes that the multicast session that the UE 100 is receiving itself has been released or deactivated, and can deactivate the operation of the multicast reception.

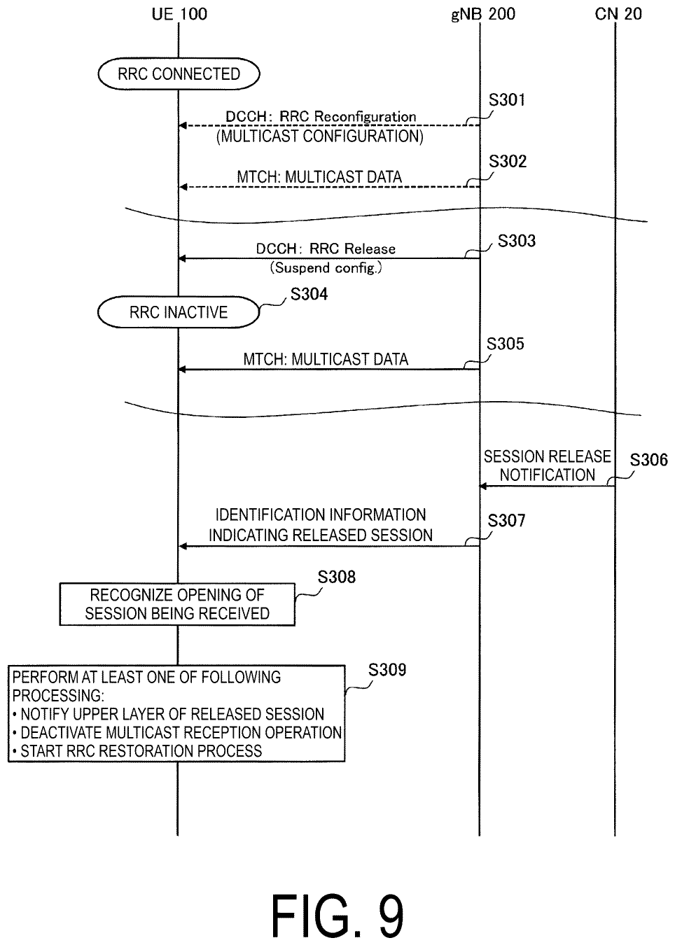

FIG. 9 is a flowchart illustrating an operation example of the mobile communication system 1 according to the present operation pattern. Prior to the present operation, it is assumed that the UE 100 has joined a multicast session. Here, differences from the first and second operation patterns described above will be mainly described, and overlapping description will be omitted.

The operations from step S301 to step S305 are the same as and/or similar to those of the operation patterns described above. Here, in step S305, the UE 100 in the RRC inactive state receives multicast data on the MTCH via a multicast session based on the multicast configuration. The UE 100 receives the multicast data on the MTCH via the multicast session based on the multicast configuration.

In step S306, the gNB 200 receives a notification of multicast session release from the CN 20.

In step S307, the gNB 200 transmits identification information indicating the multicast session to be released. The UE 100 receives the identification information. In the following, it is mainly assumed that the multicast session that the UE 100 is receiving is released.

The gNB 200 may transmit a paging message on a Paging Control Channel (PCCH), the paging message including an identifier (TMGI) of the multicast session to be released. For example, the gNB 200 transmits a paging message including a list of identifiers (TMGIs) of each multicast session to be released (e.g., a “release group list”).

The gNB 200 may transmit a MAC CE containing the index values of the multicast sessions to be released, for example, on the MTCH (using the group RNTI). For example, the gNB 200 may transmit a MAC CE containing a list of the index values of the multicast sessions to be released. Here, the index values are information having a bit length shorter than that of the session identifiers (TMGIs). The index values are associated with session identifiers (TMGIs) or MRB IDs. In this case, it is assumed that mapping information indicating a correspondence relationship between the index values and the session identifiers (TMGIs) or the MRB IDs is configured in advance for the UE 100 by using SIBs, the MCCH, or the dedicated RRC message (step S301 or S303). An index value indicating a discontinuous reception (DRX) configuration configured for each multicast session may be used as the index value.

In step S308, the UE 100 recognizes release of the multicast session that the UE 100 is receiving based on the identification information received from the gNB 200 in step S307. In this case, the UE 100 may deactivate a reception operation of the MRB corresponding to the multicast session, for example, PDCCH monitoring. The AS of the UE 100 may notify the upper layer (NAS) of the UE 100 of the deactivation of the multicast session. For example, the AS of the UE 100 may notify the upper layer (NAS) of the identifier (TMGI) of the released multicast session. The UE 100 may start RRC recovery and transmit an RRC Resume Request message to the gNB 200.

### (4) Other Embodiment

Although the multicast reception in the RRC inactive state has been mainly described in the above-described embodiments, the operations according to the above-described embodiments may be applied to multicast reception in the RRC idle state. That is, the “RRC inactive state” in the operations according to the above-described embodiments and their modification may be read as “RRC idle state”. With respect to the RRC idle state, RRC recovery (Resume) can be read as RRC establishment (Establishment).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a mobile termination (MT) of the IAB node.

Although the term “network node” mainly refers to a base station, it may also refer to an apparatus of a core network or a part (CU, DU or RU) of a base station.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (5) Supplementary Note

Features relating to the embodiments described above are described below as supplements.

### Supplementary Note 1

A communication method used in a mobile communication system that provides a multicast/broadcast service (MBS), the communication method including the steps of: receiving, by a user equipment being in a radio resource control (RRC) inactive state and having joined a multicast session, multicast data from a network node via the multicast session; and determining, by the user equipment, to transition from the RRC inactive state to an RRC connected state in response to detection of generation of uplink data belonging to the multicast session.

### Supplementary Note 2

The communication method described in supplementary note 1, further comprising the steps of:
initiating, by the user equipment, an RRC recovery process for the transitioning to the RRC connected state; and
transmitting, by the user equipment, notification information indicating the generation of the uplink data belonging to the multicast session to the network node in the RRC recovery process.

### Supplementary Note 3

A communication method used in a mobile communication system that provides a multicast/broadcast service (MBS), the communication method including the steps of:
receiving, by a user equipment in a radio resource control (RRC) connected state, a multicast configuration required for reception of a multicast session together with version information of the multicast configuration from a network node;
storing, by the user equipment, the version information; and
receiving, by the user equipment having transitioned from the RRC connected state to an RRC inactive state, broadcast information from the network node, the broadcast information including version information of a latest multicast configuration of the multicast session.

### Supplementary Note 4

The communication method described in supplementary note 3, further comprising:
determining, by the user equipment, to transition from the RRC inactive state to the RRC connected state based on the version information in the broadcast information being different from the stored version information.

### Supplementary Note 5

A communication method used in a mobile communication system that provides a multicast/broadcast service (MBS), the communication method including the steps of:
receiving, by a user equipment being in a radio resource control (RRC) inactive state and having joined a multicast session, multicast data from a network node via the multicast session; and receiving, by the user equipment, identification information of one or more multicast sessions to be released or deactivated from the network node.

### Supplementary Note 6

The communication method described in supplementary note 5, further including: specifying, by the user equipment, release or deactivation of a multicast session that the user equipment is receiving based on the identification information.

### Supplementary Note 7

The communication method described in supplementary note 5 or 6, wherein receiving the identification information includes receiving a paging message including the identification information or a media access control and control element (MAC CE) including the identification information.

### (6) Supplementary Notes

Supplementary information relating to the embodiments described above is described below.

### Introduction

The work for enhancing the MBS (eMBS) is intended to support multicast reception by UE in the inactive state as follows.
To define support for multicast reception by UE in the RRC inactive state.
   PTM configuration of the UE receiving multicast in the RRC inactive state
   Investigation of the impact of mobility and state transition on the UE receiving multicast in the RRC inactive state (seamless/lossless mobility is not mandatory).

RAN2#119e started a discussion for this purpose and reached a series of agreements. Moreover, details of multicast reception in the inactive state are discussed in this additional note.

### Discussion

### Distribution Mode Baseline

Release 17 defines two distribution modes that are a mode called “distribution mode 1” for a multicast session and a mode called “distribution mode 2” for a broadcast session. While, in the distribution mode 1, reception on the MTCH is configured with RRCReconfiguration only for UE in a connected state, in the distribution mode 2, reception on the MTCH is configured with the MCCH for all UEs in an RRC state.

RAN2#119e has defined that these distribution modes are candidates for multicast reception in the inactive state, i.e., option 1 and option 2.

For PTM configuration delivery, RAN2 further studies the following solutions.
Option 1: Dedicated signaling
Option 2: SIB+MCCH-based solution
A “combination” of the options is not excluded.

According to the supplementary notes submitted to RAN2#119e, the support for multicast reception in an inactive state is motivated for two reasons: network congestion and UE power saving.

Observation 1: Network congestion and UE power saving are the motivation for multicast reception in the inactive state.

According to this contribution, option 1 is superior to option 2 in terms of signaling overhead that directly affects network congestion. In other words, from the motivational point of view, it makes no sense to allow additional signaling overhead caused by SIB20 and MCCH transmission when the network is in congestion.

Observation 2: Signaling overhead caused by MCCH transmission is significant under conditions of network congestion.

From the perspective of UE in the inactive state, the UE performs DRX for paging/monitoring and reduces power consumption. When option 2 is used for multicast reception in the inactive state, the UE needs to perform an additional DRX activity, that is, MCCH monitoring, which causes additional power consumption. Therefore, this option is not consistent with the motivation of the UE for reducing power consumption.

Observation 3: MCCH monitoring activities cause additional UE power consumption in the RRC inactive state.

Of course, in option 1, the UE is obliged to start the RRC Resume procedure when the MBS configuration is provided or updated. However, it is clarified that “when the MRB is configured and the session is active, the configuration is not frequently changed during the session”. It has also been agreed in RAN2#119e that “continuation of the multicast service after cell reselection in the RRC inactive state (i.e., without resuming the RRC connection) is supported (when configuring a new cell is available to the UE)”. Therefore, there is no big problem in network congestion and power consumption of the UE.

Release 17 defines that multicast services are provided in so-called distribution mode 1 (option 1), which is commonly recognized in RAN2 as the basic concept of the multicast design. The Releases have no reason to make such significant changes.

In view of the above description, option 1 is a simple way to provide a PTM configuration.

Proposal 1: The RAN2 needs to agree that the PTM configuration is provided by dedicated signaling, that is, option 1.

### Transition of RRC States

RAN2#119e has considered that further study is needed for change in RRC states.

In Release 18, multicast reception for UE in an inactive state supports at least the following scenarios, based on the premise that the UE already has a valid PTM configuration.
Scenario 1: The UE was connected and received multicast, and when it becomes inactive, it continues receiving multicast.
Scenario 2: The UE has joined a multicast session and has been induced to be inactive.

Further study is needed for a case in which a state changes, such as a case in which a service is not provided in an inactive state.

It is believed that change in RRC states has many aspects from the network and UE's perspective. Therefore, each case will be described below.

Subcase 1: Release/stop of a multicast session

RAN2#119e has defined subcase 1 as an example.

Further study is needed for a case in which a state changes, such as a case in which a service is not provided in an inactive state.

It is considered that, when the UE in the inactive state is receiving the MBS service, the multicast session is released or stopped, and the gNB stops the transmission of the PTM/MTCH accordingly. In this case, the UE has no reason for continuing monitoring the MTCH; however, as long as the PTM configuration is not deleted, the UE needs to monitor the MTCH. From the viewpoint of power saving of the UE, it is desirable to stop monitoring the MTCH as soon as possible.

Observation 4: It is inefficient from the viewpoint of power consumption of the UE that the UE continues monitoring the PTM/MTCH after the multicast session is released or deactivated.

Thus, the UE needs to be informed by the gNB of the release/deactivation of the configured multicast session. Further study is needed as to whether to handle release and inactivity separately and which signaling (such as MACCE or paging) is used for this notification.

Proposal 2: When a multicast session is released or deactivated, the UE in the inactive state needs to be notified of the intent and agree to stop monitoring the PTM/MTCH as soon as possible.

Subcase 2: Selective Transition

RAN2#119e has reached the following agreement on subcase 2.

The gNB is entrusted to determine whether the UE (or UEs) can receive a multicast session in the inactive state. Further study is needed as to what information is to be provided to the gNB in order to make the decision (related to the discussion of SA2).

It is supported that the gNB transmits one multicast session to UEs in the connected and inactive states in the same cell. Further study is needed as to how the gNB would configure the support. It is assumed that the network can select which UE would receive in the RRC inactive state and which UE would receive in the RRC connected state, and can move the UE between states for reception of the multicast service.

To release UE to be inactive, the gNB may select UE to release in the same manner as the current, that is, in RRC Release with Suspend Config., based on UE capabilities, UE assistance information, and/or CN assistance information (when defined). Therefore, with respect to RRC release messages, no enhancement for selective transitions of the UE is foreseen.

On the other hand, when the gNB pages the UE to be inactive, the gNB transmits a multicast active notification, that is, RAN paging including the TMGI. However, according to current specifications, all UEs start the RRC Resume procedure when the paging message includes the TMGI of interest. When the gNB only includes the UE-ID for selective paging (i.e., no TMGI for paging selected UE of Release 18), UE of Release 17 that is inactive and waiting for multicast activation cannot be paged. Thus, RAN2 needs to discuss whether the notification of multicast activation needs to be extended to page a subset of UE.

Proposal 3: RAN2 needs to discuss whether the notification of multicast activation (i.e., RAN paging using the TMGI) needs to be enhanced to page a subset of UE.

Subcase 3: QoS Enforcement

RAN2#119e has reached the following agreement on subcase 3.

HARQ feedback and PTP are not supported in the RRC-inactive multicast reception.

According to agreement, multicast reception in the inactive state is the same as or similar to the MBS broadcast reception defined in Release 17 (so-called distribution mode 2). MBS broadcast is of the best-effort type.

On the other hand, in a multicast session, it is important to guarantee QoS/reliability. RAN2 #119e has proposed to introduce threshold values for reception qualities such as RSRP and BLER, which are considered to be used to ensure a certain level of QoS requirement for multicast reception. The threshold values are also useful for the network to manage QoS requirements. When inactive multicast reception does not meet the corresponding QoS requirements, the UE transitions to the connected state and needs to utilize HARQ feedback/retransmission or PTP (or SplitMRB) to ensure the reception quality.

Observation 5: Even when the UE is in the inactive state, the multicast session needs to ensure certain QoS requirements.

Regarding the threshold values for RSRP, since the NRMBS assumes single-cell transmission, it is considered that the UE needs to always transition to the connected state every time the UE moves to a cell edge or performs cell reselection. This may not be said to be an optimal operation depending on deployments from the viewpoint of network congestion and power saving of the UE.

The threshold values for BLER are considered to be simpler to ensure the QoS requirements. Therefore, these options need to be discussed to introduce transitions of RRC states based on reception qualities.

Proposal 4: RAN2 needs to agree that the UE in the inactive state transitions to the connected state when the reception quality becomes worse than the threshold value (such as RSRP or BLER).

Subcase 4: Mobility and Service Continuity

RAN2#119e has agreed on the following description for subcase 4.

Continuation of the multicast service after cell reselection in the RRC inactive state (i.e., without resuming the RRC connection) is supported (when a configuration of a new cell is available to the UE). Further study is needed as to whether the UE needs to resume the connection. Further study is needed as to the influence of inter-GNB mobility on RAN3. When cell reselection for a neighboring cell is performed during an active multicast session, when the UE in the inactive state is not able to use the session configuration within a new cell, the UE needs to resume the RRC connection to obtain the multicast MRB configuration.

In distribution mode 1 of Release 17, the PTM configuration is provided by an RRC Reconfiguration message, so the UE needs to be always connected to receive the PTM configuration. In order to avoid a transition to the connected state, it is conceivable to provide a PTM configuration updated using an RRC release message. In this case, when the UE transmits an RRC Resume Request message, the gNB responds with an RRC Release containing the PTM configuration. Thus, the UE does not need to transition to the connected state in order to be provided with the updated PTM configuration. This procedure can be used during cell reselection (i.e., started by the UE when no PTM configuration is available in a new cell) or during RAN paging (i.e., started by the network when the PTM configuration needs to be updated).

Proposal 5: RAN2 needs to agree that RRC Release will be enhanced to provide a PTM configuration.

Another issue to consider is the impact of UE mobility under the assumption that “seamless/lossless mobility is not needed” as described in the WID. In Release 17, it is clear that the PTM configuration in distribution mode 1 is valid only within in the cell in which the UE is configured. When a handover is performed, the target cell connects to a new PTM configuration to reconfigure the UE. On the other hand, when inactive UE performs mobility in the idle mode, the time when the existing PTM configuration is no longer valid within the reselected cell (i.e., a new cell) can be considered as the starting point.

In order for the UE to be handed over from the serving cell to the target cell or reconfigured by the reselected cell, requiring inactive UE to always transition to a connected state (e.g., before or after performing cell reselection) may be the simplest solution with minimal impact on the specification.

As a more efficient method, since the PTM configuration is valid in the RNA, the gNB needs to be able to apply the same configuration in the RNA of each UE. An advantage of this method is that the UE in the inactive state does not need to reconfigure and can continue to receive the MTCH in the RNA. On the other hand, the RNA is UE-specific, which leads to increased network complexity.

A more flexible and less complex method is that the gNB provides a cell list within the configuration, whereby the configuration is considered valid in the cells on the list. The cell list can be configured to be either cell-specific, DU/CU-related, UE-specific, RNA-related, MRB area-specific, or MBS service area-specific, depending on the NW implementation.

Therefore, the RAN2 needs to discuss whether to introduce the area scope of such configurations.

Proposal 6: For the solution based on distribution mode 1, the RAN2 needs to discuss whether the configuration for receiving the MTCH is valid within the serving cell or valid within the area (such as the RNA or cell list).

### REFERENCE SIGNS

1: Mobile communication system
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method used in a mobile communication system configured to provide a multicast/broadcast service (MBS), the communication method comprising the steps of:
receiving, by a user equipment being in a radio resource control (RRC) inactive state and having joined a multicast session, multicast data from a network node via the multicast session; and
determining, by the user equipment, to transition from the RRC inactive state to an RRC connected state in response to detection of generation of uplink data belonging to the multicast session.

2. The communication method according to claim 1, further comprising the steps of:
initiating, by the user equipment, an RRC recovery process for the transitioning to the RRC connected state; and
transmitting, by the user equipment, notification information indicating the generation of the uplink data belonging to the multicast session to the network node in the RRC recovery process.

3. A communication method used in a mobile communication system configured to provide a multicast/broadcast service (MBS), the communication method comprising the steps of:
receiving, by a user equipment in a radio resource control (RRC) connected state, a multicast configuration required for reception of a multicast session together with version information of the multicast configuration from a network node;
storing, by the user equipment, the multicast configuration and the version information; and
receiving, by the user equipment having transitioned from the RRC connected state to an RRC inactive state, broadcast information from the network node, the broadcast information comprising version information of a latest multicast configuration of the multicast session.

4. The communication method according to claim 3, further comprising:
determining, by the user equipment, to transition from the RRC inactive state to the RRC connected state, based on the version information in the broadcast information being different from the stored version information.

5. A communication method used in a mobile communication system configured to provide a multicast/broadcast service (MBS), the communication method comprising the steps of:
receiving, by a user equipment being in a radio resource control (RRC) inactive state and having joined a multicast session, multicast data from a network node via the multicast session; and
receiving, by the user equipment, identification information of one or more multicast sessions to be released or deactivated from the network node.

6. The communication method according to claim 5, further comprising:
specifying, by the user equipment, release or deactivation of the multicast session that the user equipment is receiving, based on the identification information.

7. The communication method according to claim 5, wherein the receiving the identification information comprises receiving a paging message comprising the identification information or a media access control and control element (MAC CE) comprising the identification information.

8. A user equipment in a mobile communication system configured to provide a multicast/broadcast service (MBS), the user equipment comprising:
a receiver circuitry, receiving, multicast data from a network node via the multicast session, the user equipment being in a radio resource control (RRC) inactive state and having joined a multicast session; and
a controller circuitry, determining, to transition from the RRC inactive state to an RRC connected state in response to detection of generation of uplink data belonging to the multicast session.
